(19) United States
(12) Patent Application Publication
(10) Pub. No.: US 2007/0056526 A1
(43) Pub. Date: Mar. 15, 2007

(54) Locator for Dog Collar Transmitter

(75) Inventors: Jim Gianladis, Sidney, NE (US); Darrell Douglas, Sidney, NE (US); Kurt Grove, Sidney, NE (US)

Correspondence Address: MARSH, FISCHMANN & BREYFOGLE LLP, 3151 SOUTH VAUGHN WAY, SUITE 411, AURORA, CO, 80014, US

(73) Assignee: Cabela's, Inc., Sidney, NE (US)

(21) Appl. No.: 11/276,906

(22) Filed: Mar. 17, 2006

Related U.S. Application Data
(60) Provisional application No. 60/694,637, filed on Jun. 28, 2005.

(51) Int. Cl. A01K 15/02; A01K 27/00

(52) U.S. Cl. 119/721

(57) ABSTRACT

An electronic animal training system including locating functionality for locating a handheld transmitter of the electronic animal training system and associated methods are provided. The system generally includes an indicator mechanism associated with the handheld unit for providing a user perceptible indicator to facilitate locating the handheld unit. The system also generally includes an activator mechanism for activating the indicator mechanism. The activator mechanism may be associated with one or more of a training unit, a dedicated locator unit and the handheld unit. The activator mechanism may activate the indicator mechanism via wireless communication or via a motion sensor, among others.

### CROSS REFERENCE TO RELATED APPLICATION

This application claims priority to U.S. Provisional Patent Application Ser. No. 60/694,637 filed Jun. 28, 2005, entitled “Locator For Dog Collar Transmitter”, the contents of which are incorporated herein by reference in their entirety.

### FIELD OF THE INVENTION

The present invention relates generally to electronic animal training systems that utilize an electronic transmitter unit to convey commands or command signals to an electronic receiver unit attached to an animal. More particularly, the present invention is directed to an electronic animal training system that provides locating capability for the electronic transmitter unit.

### BACKGROUND

The use of wireless electronic training systems for training animals to obey commands is well established. Generally, these electronic training systems utilize an electronic receiver unit that may be mounted to or attached to an animal (e.g., via a collar or other accessory) and a transmitter unit for use in sending signals (e.g. via a wireless RF link) to the animal receiver unit. Often, the systems are utilized for training dogs, and in particular, hunting dogs.

Electronic training systems generally utilize a collar including a receiver unit and a handheld transmitter unit that is adapted to send one or more transmission signals to the receiver unit of the collar. In such systems, the transmitter may be operative to transmit multiple different transmission signals. Such transmission signals are received by the receiver unit, which, in turn, generates an output for disciplining or instructing the animal. For example, verbal commands or audible tones may be output at the receiver unit to instruct the animal. Accordingly, the receiver assembly may include a speaker to produce audible/sub-audible output signals. Further, discipline may be provided by way of negative reinforcement stimuli (e.g., electronic shocks). In this regard, the collar may include one or more electrodes adapted to engage the tissue of an animal in order to provide, for example, electronic shocks, which may be of varying magnitude.

As will be appreciated, in many instances electronic animal training systems are utilized in the field under actual use conditions, for example, while hunting. Hunters are often occupied with a multitude of gear (e.g., guns, decoys, blinds etc.) in addition to the handheld transmitter of their electronic animal training system. Accordingly, the handheld transmitter may become misplaced or lost. Generally, electronic training systems are moderately expensive systems and the loss of the handheld transmitter may result in loss of the system as well as a substantial financial consequence.

### SUMMARY OF THE INVENTION

In view of the foregoing, one objective of the present invention is to provide systems employable to locate a transmitter unit of a electronic animal training system.

Another objective is to provide methods for locating a transmitter unit of an electronic animal training system.

Yet another objective is to enable the location of a transmitter unit utilizing a preexisting component of an electronic animal training system.

Still another objective is to enable the location of a transmitter unit of an electronic animal training system utilizing one or more components separate from the transmitter unit and a receiver unit.

Yet another objective is to selectively enable one or more user perceptible indicators that facilitate locating a transmitter unit without significant disturbance to the surroundings.

Another objective is to enable the location of a transmitter unit free from input of a user. A related objective is to enable a determination, free from input of a user, that the transmitter unit does not need locating.

Still another objective is to enable the selective activation and deactivation of a locating capability of the electronic animal training system.

One or more of the above objectives and additional advantages may be realized by an inventive system that includes locating functionality associated with the training signal transmitter unit. More particularly, the system may include a training signal transmitter unit of an electronic animal training arrangement, wherein the training signal transmitter unit includes an indicator mechanism adapted to provide a user perceptible indication for use in locating the training signal transmitter unit. The system further includes an activator mechanism for activating the indicator mechanism. Since the indicator mechanism is associated with the training signal transmitter unit, the training signal transmitter unit may be operable to provide a user perceptible indication (e.g., a visual and/or audible indication) so that a user may locate the training signal transmitter unit. As discussed in further detail below, this user perceptible indication may be provided by the training signal transmitter unit sua sponte or in response to a signal received by the training signal transmitter unit.

As noted, an activator mechanism is provided with the system to activate the indicator mechanism. In one approach, the activator mechanism may comprise a locating signal that may be received by the training signal transmitter unit, such as a radio frequency (RF), wireless, infrared, ultrasonic or similar style signal. Upon receipt of the locating signal, the training signal transmitter unit may activate the indicator mechanism, thereby providing one or more user perceptible indicators to facilitate location of the transmitter unit.

In one approach, the activator mechanism may be associated with a training signal receiver unit of the electronic animal training system (“receiver unit”), wherein the receiver unit is operable to receive a training signal from the training signal transmitter unit to provide a responsive command to an animal interconnected therewith, and wherein the receiver unit is further operable to transmit the above described locating signal. Thus, in this approach, a pre-existing component of the electronic animal training system (e.g., a transceiver of the receiver unit) may be utilized to locate the training signal transmitter unit. In a particular embodiment, the receiver unit may be located within the animal collar. In this regard, if a user cannot locate the training signal transmitter unit but can locate the animal collar, the training signal transmitter unit may be prompted, via the receiver unit, to emit an audible tone or other user perceptible indicator such that the training signal transmitter unit may be located.

The activator mechanism may comprise a button, or similar component, adapted to activate a transmitter (e.g., a transmitter portion of a transceiver). The transmitter may be operable, upon activation, to transmit the above noted locating signal to activate the indicator mechanism. In one embodiment, an activator mechanism is associated with the receiver unit and comprises a transceiver operable to receive a training signal from the training signal transmitter unit and to transmit a locating signal (e.g., a wireless locating signal).

In another approach, the activator mechanism may be associated with a dedicated locator unit, wherein the dedicated locator unit is operable to transmit the above noted locating signal. Thus, in this approach, a component separate from both the training signal transmitter unit and the receiver unit may be utilized to locate the training signal transmitter unit. In this regard, the dedicated locator unit may be stored remote of the training signal transmitter unit and the receiver unit (e.g., a known location, such as the interior of a vehicle or attached to the clothing and/or gear of the user, or otherwise disposed proximal to the user) so that if both units are lost, either or both may be located via such dedicated locator unit. As may be appreciated, the dedicated locator unit need not be accessed or manipulated, except when the location signal is desired, and therefore is less likely to be misplaced. In one embodiment, the locator unit may include a securing means for securing the locator unit to a user. Examples of such securing means include, but are not limited to, hooks, snaps, clamps, spring-loaded devices, rings and other such devices. Thus, the locator unit may be securely fastened to a user such that it is restricted from being lost and/or removed from the user.

One or both of the receiver unit and the training signal transmitter unit may include an indicator mechanism. In a preferred embodiment, the training signal transmitter unit and the receiver unit both include an indicator mechanism to facilitate the locating of such units should such units need locating. Thus, in this embodiment, the training signal transmitter unit and the receiver unit may be located via one another (i.e., a component of the system). In a related embodiment, the dedicated locator unit may be operable to selectively activate an indicator mechanism of the training signal transmitter unit and/or the receiver unit. Thus, in this embodiment, each or both of the training signal transmitter unit and the receiver unit may be located via a separate component not associated with either of the training signal transmitter unit and the receiver unit.

As may be appreciated, an activator mechanism may be associated with the receiver unit and/or the dedicated locator unit. Further in this regard, two or more activator mechanisms may be associated with a single receiving unit and/or a single dedicated locator unit. In one approach, the activator mechanism may comprise two or more buttons, or similar components, interconnected to a transmitter, wherein the first button is operable to activate a first user perceptible indicator (e.g., an audible indicator) of the indicator mechanism (e.g., via a first locating signal), and wherein the second button is operable to activate a second user perceptible indicator (e.g., a visual indicator) of the indicator mechanism (e.g., via a second locating signal). Thus, in this approach, a user may selectively activate a desired user perceptible indicator based upon the operation of a selected one of the buttons. As may be appreciated, this approach is useful when it is desired to activate a user perceptible indicator that will facilitate location of a training signal transmitter unit and/or receiver unit without significantly disturbing the surroundings (e.g., a visual indicator). Thus, hunters may be able to locate a training signal transmitter unit and/or receiver unit without scaring off game.

In another approach, an activator mechanism may be associated with the training signal transmitter unit. In one embodiment, the activator mechanism may comprise a motion sensor adapted to provide periodic output signals, wherein such output signals may vary in the presence of motion and wherein such output signals may remain unchanged in the absence of motion. Upon determining that the output signal of the motion sensor is not varying (i.e., remains unchanged for a predetermined period of time), the activator mechanism may activate the indicator mechanism of the training signal transmitter unit. In a particular embodiment, the activator mechanism may be operable to automatically activate the indicator mechanism after the motion sensor has been stationary for a predetermined period of time. In one embodiment, the activator mechanism may automatically activate one of an audible indicator and a visual indicator, via the indicator mechanism, after the motion sensor has been stationary for predetermined period of time. Thus, in this approach, the system may be operable to automatically locate the training signal transmitter unit free from input from a user.

In one embodiment, the motion sensor may be operable to detect relatively slight movements of a user (e.g., breathing), wherein the user appears to be moving relative to the motion sensor, but the user appears motionless to others (e.g., during hunting of game). Thus, in this embodiment, the system may be operable to determine that the training signal transmitter unit does not require locating free from input of a user.

The activator mechanism may include logic for establishing the above-noted predetermined period of time, wherein the logic is operable to set the predetermined period of time to least one of a first predetermined period of time and a second determined period of time. In a particular embodiment, the first predetermined period of time may be set by a manufacturer. In a related embodiment, the second predetermined period of time may be definable by a user. In another embodiment, the activator mechanism may be selectively activated and deactivated by user. Thus, in this embodiment, a locating capability/functionality of the system may be selectively activated such that the system is operable only at desired times (e.g., activated during use and deactivated otherwise).

In another approach, the activator mechanism may comprise a distance determiner, wherein the distance determiner is operable to determine a distance between a training signal transmitter unit and a receiver unit. The distance determiner may further be operable to automatically activate an indicator mechanism of a training signal transmitter unit when the training signal transmitter unit exceeds a predetermined distance from a receiver unit. In one embodiment, the predetermined distance may be definable by user. As may be appreciated, the distance determiner may be associated with one or both of a training signal transmitter unit and a receiver unit.

The present invention also provides various methodologies relating to locating a training signal transmitter unit of an electronic animal training system. In one characterization, the method includes the steps of receiving an indication that a training signal transmitter unit needs locating and activating a user perceptible indicator for indicating a location of the training signal transmitter unit.

In one approach, the method may further include the steps of initiating a locating signal, remote from the training signal transmitter unit, wherein the receiving step further comprises the step of receiving the locating signal at the training signal transmitter unit. In one embodiment, the initiating step may further comprise the step of operating a button interconnected to one of a receiver unit and a locating unit associated with the electronic animal training system. In another embodiment, the initiating step may comprise the steps of determining a distance between the training signal transmitter unit and a receiver unit, and automatically sending the locating signal to the training signal transmitter unit when a distance between the training signal transmitter unit and the receiver unit exceeds a predetermined distance.

In another approach, the receiving step may further comprise the step of sensing absence of motion of the training signal transmitter unit, wherein the method further comprises the step of automatically commencing the above noted activating step. In another approach, the method may further comprise the step of deactivating the user perceptible indicator (e.g., in conjunction with the motion sensor). In one embodiment, the deactivating step may comprise the step of operating a button interconnected to the training signal transmitter unit. In another embodiment, the deactivating step may comprise the step of operating a button interconnected to one of a receiver unit and a locating unit.

Numerous additional aspects, features and advantages of the present invention will become apparent to those skilled in the art upon consideration of the further description that follows.

### BRIEF DESCRIPTION OF THE DRAWING

FIG. 1 illustrates one embodiment of an electronic animal training system of the present invention.

FIG. 2 illustrates a circuit diagram relating to one embodiment of an output module useful in accordance with the present invention.

FIG. 3 illustrates one embodiment of a dedicator locator unit employable with the electronic animal training system of FIG. 1.

FIG. 4 illustrates a circuit diagram relating to one embodiment of a motion sensor useful in accordance with the present invention.

### DETAILED DESCRIPTION

Reference will now be made to the accompanying drawings, which at least assist in illustrating the various pertinent features of the present invention. In this regard, the following description of an electronic animal training system is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. The embodiments described herein are specifically directed to an animal training system for training dogs, however, the present invention is not limited to this application.

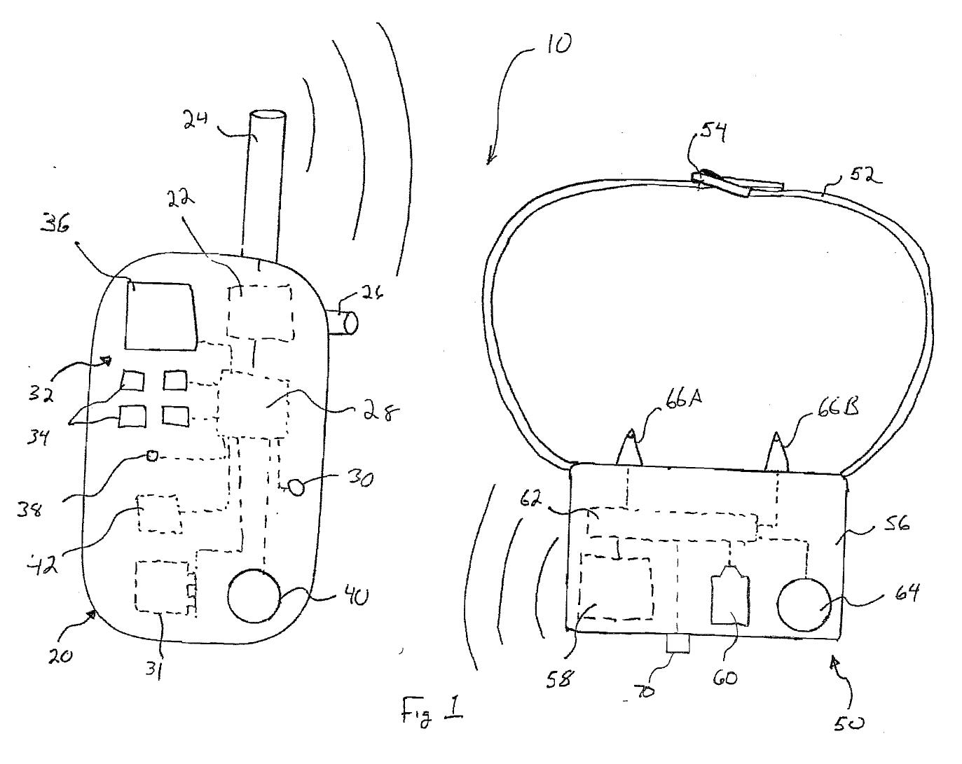

One embodiment of a system useful in conjunction with the present invention is depicted in FIG. 1. The system 10 includes a handheld unit 20 (i.e., a training signal transmitter unit) for wirelessly communicating with a training unit 50 (e.g., collar comprising a receiver unit). The training unit 50 (e.g., a dog collar assembly) may be mountable about the neck of an animal and operable to wirelessly communicate with the handheld unit 20. In the present embodiment, the system 10 utilizes radio frequency (RF) signal signals for wireless communication. However, it will be appreciated other signal mediums, such as infrared, ultrasonic or the like may be utilized.

The handheld unit 20 may include a transmitter 22 operative for wireless communications with a receiver 58 of the training unit 50. As shown, the transmitter 22 is interconnected to an antenna 24 and may be operative to send wireless signals (e.g., one or more training signals) that may be received by the training unit. In one embodiment, the transmitter 22 may comprise a transceiver operative to send and receive wireless signals. The handheld unit 20 may further include an adjustment knob 26 for use in selectively adjusting the frequency of the transceiver 22. The handheld unit 20 may be powered by a power supply 31 (e.g., a rechargeable battery) and may include a processor 28 (e.g., a microprocessor and/or controller) operative to control various functions of the handheld unit 20.

The handheld unit 20 may be operative to receive inputs from a user through a user interface assembly 32. The interface assembly 32 may include a keypad 34, which may include one or more preprogrammed functions, a display 36 (e.g., an LCD display), and/or a microphone 38. The individual keys of the keypad 34 may permit a user to send one or more preset training signals to the training unit 50. Such signals may result in the training unit 50 providing a shock, vibrating, and/or generating an audible output. A microphone 38 may be incorporated into the handheld unit 20 to permit a user to provide verbal commands, which may be transmitted to and output at the training unit 50. The display 36 may provide an indication of a selected transmitting frequency and/or receiving frequency and or other information regarding the settings of the handheld unit 20.

A speaker 40 may be provided with the handheld unit 20 for generating one or more audible indicators that may be heard by a user. In the illustrated embodiment, the handheld unit 20 further includes a light source 30, such as an LED, to provide one or more visible outputs. Such audible visual indicators (together or individually selectable) may be utilized to locate the handheld unit 20. As will be appreciated, the exact configuration of the handheld unit 20 is a matter of design choice.

The training unit 50 may include a strap 52 and buckle 54 for securing the training unit 50 to an animal (e.g., a dog). Interconnected to the strap 52 may be a housing 56 for housing the various electronic components of the training unit 50. The housing 56 may be designed to protect the electronic components contained therein. Disposed within the housing 56 may be a receiver 58 operative to receive wireless signals from the handheld unit 20. In one embodiment, the receiver 58 comprises a transceiver operable to send wireless signals that may be received by the handheld unit 20 (e.g., one or more locating signals). The receiver 58 may include an internal antenna, or the receiver 58 may be interconnected to an external antenna (not shown).

The training unit 50 may also include a source of electrical power, such as a battery 60, a processor 62 (e.g., a controller and/or microprocessor), a speaker 64 and/or a light source (not illustrated), wherein the speaker 64 and/or light source may be utilized to facilitate locating the training unit 50. First and second electrodes 66A and 66B may be mounted to the outside surface of the housing 56.

The processor 62 may be used to control various functions performed by the receiver unit 50. More specifically, the processor 62 may be operative to initiate one or more functions in response to signals received from the handheld unit 20. For example, the processor 62 may be electrically connected to the speaker 64, which may be operative to emit one or more audible outputs, such as a tone or series of tone bursts in response to control signals. As may be appreciated, such audible outputs may be audible to the user, the animal or both. Additionally, the speaker 64 may emit verbal outputs that correspond to verbal inputs of the user sent via the handheld unit 20.

The processor 62 may also be interconnected to the electrodes 66A and 66B, which may be attached to the training unit 50 so as to be in contact with the neck of the animal wearing the collar. Upon receipt of appropriate control signals, the processor 62 may facilitate the application of a charge across the electrodes 66A and 66B. As may be appreciated, one or both of the training unit 50 and the handheld unit 20 may include substantially waterproof seals to avoid water damage.

In one embodiment, the training unit 50 may be operative to initiate locating functionality to facilitate locating of the handheld unit 20. In this regard, the training unit 50 may include one or more locator buttons 70 operatively interconnected to the processor 62. By depressing/operating the locator buttons 70, the processor 62 may send a signal to the receiver 58, which may then transmit a predetermined signal or frequency (e.g., a locating signal). In turn, the handheld unit may include a receiver (e.g., a transceiver comprising a receiver and transmitter 22), wherein the signal/frequency from the training unit 50 may be received by the handheld unit 20. In turn, an indicator mechanism of the handheld unit 20 may be activated so that a user perceptible indicator is generated. For example, a receiver of the handheld unit 20 may receive a locating signal generated by the training unit 50. The receiver may process the received locating signal and generate an output signal, which in turn may generate a signal to activate a user perceptible indicator.

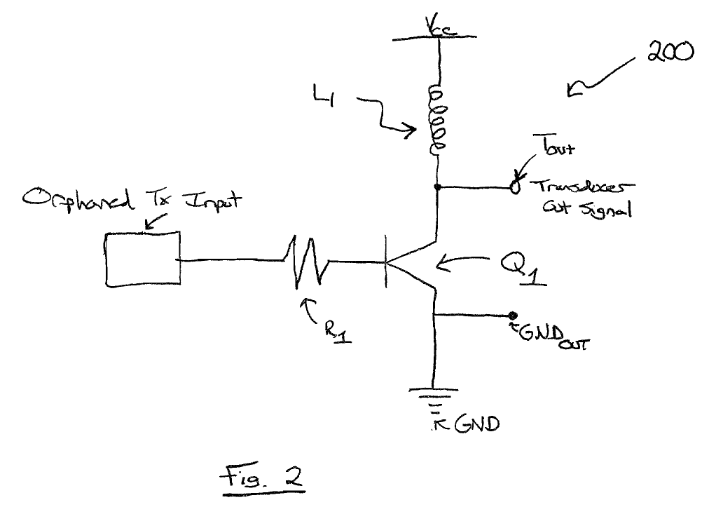

More particularly, and with reference to FIG. 2, in response to the locating signal, the receiver may generate an input signal (e.g., an ORPHANED TX INPUT signal) for input to an output module 200 of processor 28 (see FIG. 1). In this regard, a voltage may be generated as a result of the current from the ORPHANED TX INPUT signal conducting through resistor R₁. That voltage may “turn on” transistor Q₁ such that current is conducted through inductor L₁. That is, when transistor Q₁ is turned on, current travels through inductor L₁ from voltage V_{cc} to ground GND. That current flow through inductor L₁ generates a signal (e.g., TRANSDUCER OUTPUT signal) to output terminal Tₒᵤₜ of output module 200 for generating a user perceptible indicator. For example, the output module 200 may be coupled to a transducer, such as a piezoelectric transducer (e.g., speaker 40), that receives the TRANSDUCER OUTPUT signal to stimulate the transducer. The transducer, in turn, responds to the TRANSDUCER OUTPUT signal by generating an audible indicator.

In addition to facilitating the activation of the audible indicator, the output module 200 may be configured to provide other outputs for use by other components, such as the transducer described hereinabove. For example, the piezoelectric transducer may require a ground connection. As such, the output module 200 may provide ground GND via output terminal GNDₒᵤₜ.

While one embodiment has been shown and described herein, those skilled in the art should readily recognize that the invention is not intended to be limited to a particular circuit. Namely, certain components may be rearranged or alternatives may be used that fall within the scope and spirit of the invention. For example, in this embodiment, transistor Q₁ is shown as a Bipolar Junction Transistor (“BJT”). In another embodiment, transistor Q₁ may be a Metal Oxide Semiconductor Field Affect Transistor (“MOSFET”) transistor. Additionally, inductor L₁ may be, in one embodiment, a 25 millihenry (“mH”) inductor. However, those skilled in the art may choose, as a matter of design choice, to implement the features and characteristics of output module 200 using other components and/or inductors of other values. Moreover, the output module 200 may be a separate component, or the output module 200 may be integrated with the processor 28 of the handheld unit 20, as described above. Those skilled in the art are familiar with transducers, such as piezoelectric transducers, and their operational characteristics.

Referring back to FIG. 1, the handheld unit 20 may also be operative to initiate locating functionality to facilitate locating of the training unit 50. As may be appreciated, the transmitter 22 may be operative to transmit the above noted locating signal and the training unit 50 may be operative to receive the locating signal and process it to initiate an indicator mechanism. In this regard, the training unit 50 may be configured to, upon receipt of such locating signal, to activate and provide one or more user perceptible indicators (e.g., an audible indicator via speaker 64.

In a particular embodiment locating functionality may be incorporated into both the handheld unit 20 and the training unit 50 so that one unit may be located via the other unit. Thus, the handheld unit 20 may be utilized to locate the training unit 50, and vice versa. More particularly, either unit 20, 50 upon receiving a locating signal from the other unit 50, 20 may emit one of several user perceptible indicators (e.g., a series of distinctive audible tones). Such user perceptible indicators may include a continuous indicator, a single indicator and/or a periodic indicator. Once the desired unit 20, 50 is located, the indicator may be terminated, for example, by depressing a button on the corresponding unit.

The system 10 may also include a dedicated locating unit that incorporates locating functionality to facilitate locating one or both of the handheld unit 20 and training unit 50. In this regard, the locating unit may include an activator mechanism for activating one or more indicator mechanisms, such as an indicator mechanism of the handheld unit 20 and/or training unit 50.

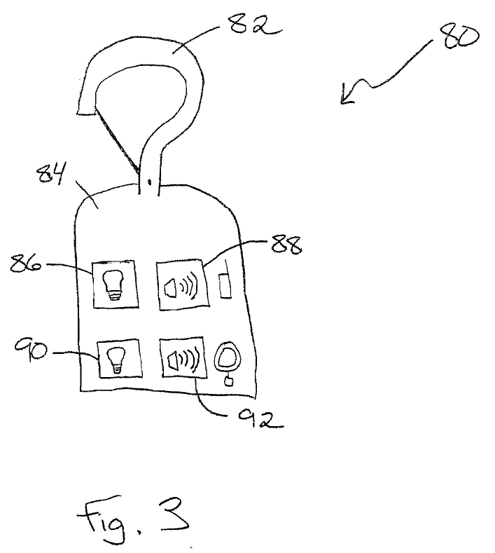

In one embodiment and with reference to FIG. 3, the locator unit 80 may include separate buttons for triggering audible 88, 92 and/or visible 86, 90 indicators for either of the training unit 50 or handheld unit 20 may be provided. Appropriate transmitters, circuitry and a power source (not shown) may also be provided in this regard. In this manner, one or both of the training unit 50 and the handheld unit 20 can be conveniently located.

The locator unit 80 may also include a housing 84 with a securing means 82 for securing the handheld unit to the hunter's clothing or gear. Securing means 82 may be any means operable to secure the locator unit to another object, such as hooks, snaps, clamps, spring-loaded devices, rings and other such devices well known to those skilled in the art. Thus, the locator unit 80 may be securely fastened to a user or other object such that it is restricted from being lost, misplaced and otherwise moved from a desired location.

In another approach and with reference back to FIG. 1, the handheld unit 20 may incorporate locating functionality that enables the handheld unit 20 to be located free from user input. For example, a stand-alone locating functionality may be incorporated into the handheld unit 20 to facilitate locating the handheld unit 20 without receipt of input from the training unit 50 or another unit (e.g. a dedicated locating unit). In one arrangement, a motion sensor 42 may incorporated into the handheld unit 20, wherein the motion sensor 42 is operative to provide a signal indicative of movement of the handheld unit 20. Accordingly, after the handheld unit 20 has been stationary for predetermined period of time, the motion sensor 42 may provide an output that initiates one or more user perceptible indicators.

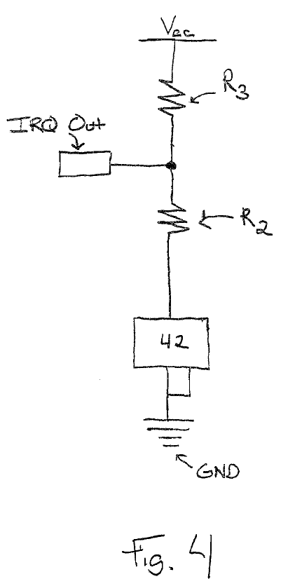

More particularly and with reference to FIG. 4, the motion sensor 42 may be configured to generate an interrupt request (“IRQ”) for the processor 28 of the handheld unit 20. For example, the motion sensor 42 may conduct current from voltage V_{cc} to ground GND when motion sensor 42 is moved (e.g., via conductive surfaces that may come in contact and conduct current from voltage VCC to ground GND). That current flow conducts through resistors R₃ and R₂ to create an output voltage at output terminal IRQ OUT. That voltage may be processed by the processor 28, wherein after the processor 28 determines that the voltage has remained uncharged for a predetermined period of time, a user perceptible indicator may be initiated via the processor 28.

In one embodiment, the resistor R3 is 100kΩ and the voltage V_{cc} is about 3 volts. However, those skilled in the art should readily recognize that the invention is not intended to be limited to particular components and/or values. For example, the motion sensor 42 may be configured in other ways to generate a processable IRQ for use in transmitting a signal. Such implementations are often a matter of design choice.

As may be appreciated, the motion sensor 42 should be operable to detect very slight movements from a user (e.g., breathing or other similar movements), since hunting often requires a user to remain relatively motion free so as not to scare game. Moreover, since the motion sensor 42 may be in human contact, mercury-free motion sensors are preferred. Motion sensors useful in accordance with the present aspect include non-mercury motion sensors that have multiple conductive surfaces that operate as a physical switch when the motion sensor is moved, such as the Comus RBS 08 03 available from Comus International, Clifton, N.J., U.S.A.

As noted above and with reference back to FIG. 1, the processor 28 may include logic operable to activate a user perceptible indicator after the motion sensor 42 has been stationary for a predetermined period of time. In one arrangement, the above noted predetermined period of time may include at least first and second predetermined periods of time. In a particular embodiment, a manufacturer may set the first predetermined period of time and a user may set and/or select the second predetermined period of time.

Other ways of determining that the handheld unit 20 may need locating are possible. For example, the processor 28 may be operative to determine periods between user inputs, where if a predetermined period of time elapses without a user input, the processor 28 may activate one or more user perceptible indicators.

In another arrangement, the system may include a distance determiner operable to determine a distance between the handheld unit 20 and the training unit 50. Upon exceeding a predetermined threshold distance, which may be user definable, the distance determiner may automatically activate one or more user perceptible indicators.

In one embodiment, the distance determiner may be associated with the handheld unit 20, whereupon exceeding a threshold distance, the distance determiner may automatically send a signal to the processor 28, which may then activate one or more user perceptible indicators. In another embodiment, the distance determiner may be associated with the training unit 50, where upon exceeding a threshold distance, the distance determiner may automatically send a signal to the processor 62, which may prompt the a transmitter of the training unit (e.g., a transceiver associated with transmitter 58) to transmit a locating signal to facilitate locating the handheld unit 20.

The processor 28 also include other functionality that may be initiated by a user, for example, through inputs to the keypad 34 to facilitate activation and deactivation of locating functionality, as desired. In one aspect, the handheld unit 20 may be operative to provide a user perceptible indicator on a continuous, one-time or periodic basis. In one embodiment, a user can set the basis through the keypad 34, as well as an output level of the user perceptible indictor(s), (e.g., a volume level and/or a light intensity level).

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A system for use in connection with an electronic animal training arrangement that includes a training signal transmitter unit for transmitting a training signal and a receiver unit for receiving the training signal and providing a responsive command to an animal, said system comprising:
an indicator mechanism, associated with said training signal transmitter unit, for providing a user perceptible indication for use in locating said training signal transmitter unit; and
an activator mechanism for activating said indicator mechanism.

2. The system of claim 1, wherein said user perceptible indication comprises one of an audible indicator and a visual indicator.

3. The system of claim 1, wherein said activator mechanism is associated with said receiver unit.

4. The system of claim 1, wherein said activator mechanism is associated with a locator unit and wherein said locator unit is separate from both said receiver unit and said training signal transmitter unit.

5. The system of claim 1, wherein said activator mechanism comprises:
a button interconnected to a transmitter, wherein said button is operable to activate said transmitter, and wherein said transmitter is operable, upon activation, to transmit a locating signal to activate said indicator mechanism.

6. The system of claim 5, wherein said button and said transmitter are associated with one of said receiver unit and a locator unit.

7. The system of claim 6, wherein said button and said transmitter are associated with said receiver unit, wherein said transmitter comprises a transceiver operable to receive said training signal and transmit said locating signal.

8. The system of claim 5, wherein said button is a first button, wherein said locating signal is a first locating signal and wherein said user perceptible indication is a first user perceptible indication, said system comprising:
a second button interconnected to said transmitter, wherein said second button is operable to activate said transmitter, wherein said transmitter is operable, upon activation, to transmit a second locating signal to active a second user perceptible indication, and wherein said first and second buttons are selectively operable to selectively activate one of said first and second user perceptible indications.

9. The system of claim 8, wherein said first user perceptible indication comprises an audible indicator and said second user perceptible indication comprises a visual indicator.

10. The system of claim 8, wherein both of said first and second buttons are associated with one of said receiver unit and said locator unit.

11. The system of claim 1, wherein said activator mechanism comprises a distance determiner operable to determine a distance between said training signal transmitter unit and said receiver unit, wherein said distance determiner is operable to automatically activate said indicator mechanism when said training signal transmitter unit exceeds a predetermined distance from said receiver unit.

12. The system of claim 11, wherein said predetermined distance is definable by a user.

13. The system of claim 1, wherein said activator mechanism is associated with said training signal transmitter unit.

14. The system of claim 13, wherein said activator mechanism comprises a motion sensor adapted to sense motion of said transmitter unit and provide output signals corresponding therewith.

15. The system of claim 14, wherein said activator mechanism is operable to activate said indicator mechanism after said motion sensor has been stationary for a predetermined period of time.

16. The system of claim 15, wherein said activator mechanism comprises logic for establishing said predetermined period of time, wherein such logic is operable to set said predetermined period of time to at least one of a first predetermined period of time and a second predetermined period of time.

17. The system of claim 16, wherein said first predetermined period of time is set by a manufacturer.

18. The system of claim 13, wherein said activator mechanism is selectively activatable and deactivatable.

19. The system of claim 1, wherein said activator mechanism comprises a locator unit operable to provide a locating signal to said training signal transmitter unit for activating said indicator mechanism.

20. The system of claim 18, wherein said locator unit is operable to provide a locating signal to said receiver unit to facilitate locating of said receiver unit.

21. A system for use in connection with an electronic animal training arrangement, said system comprising:
a training signal transmitter unit for transmitting a training signal;
a collar comprising a receiver unit for receiving the training signal and providing a responsive command to an animal interconnected therewith;
an indicator mechanism interconnected to said training signal transmitter unit, wherein said indicator mechanism is operable to provide a user perceptible indication; and
an activator mechanism for activating said indicator mechanism.

22. The system of claim 21, wherein said activator mechanism is interconnected to said receiver unit and comprises a button interconnected to a transmitter, said transmitter being operable to transmit a locating signal to activate said indicator mechanism.

23. The system of claim 21, wherein said activator mechanism comprises a motion sensor interconnected to said training signal transmitter unit, wherein said activator mechanism is operable to activate said indicator mechanism after said motion sensor has been stationary for a predetermined period.

24. The system of claim 21, wherein said activator mechanism is interconnected to a locator unit, said locator unit being separate from said training signal transmitter unit and said receiver unit, wherein said activator mechanism comprises a button interconnected to a transmitter, said transmitter being operable to transmit a locating signal to activate said indicator mechanism.

25. A method of locating a training signal transmitter unit of an electronic animal training system comprising the training signal transmitter unit and a receiver unit, the method comprising:
receiving an indication that said training signal transmitter unit needs locating; and
activating a user perceptible indicator for indicating a location of said training signal transmitter unit.

26. The method of claim 25, further comprising:
initiating a locating signal remote from said training signal transmitter unit; wherein said receiving step comprises:
receiving said locating signal at said training signal transmitter unit.

27. The method of claim 26, wherein said initiating step comprises:
operating a button interconnected to one of said receiver unit and a locating unit.

28. The method of claim 26, wherein said initiating step comprises:
determining a distance between said training signal transmitter unit and said receiver unit; and
automatically commencing said activating step when a distance between said training signal transmitter unit and said receiver unit exceeds a predetermined distance.

29. The method of claim 25, wherein said receiving step comprises:
sensing absence of motion of said training signal transmitter unit; wherein said method further comprises:
automatically commencing said activating step.

30. The method of claim 25, further comprising:
deactivating said user perceptible indicator.

31. The method of claim 30, wherein said deactivating step comprises: operating a button interconnected to said training signal transmitter unit.

32. The method of claim 30, wherein said deactivating step comprises:
operating a button interconnected to one of said receiver unit and a locating unit.
